(19) United States
(12) Patent Application Publication
(10) Pub. No.: US 2009/0134795 A1
(43) Pub. Date: May 28, 2009

(54) PLASMA DISPLAY PANEL

(76) Inventor: Tae-Joung Kweon, Suwon-si (KR)

Correspondence Address: CHRISTIE, PARKER & HALE, LLP, PO BOX 7068, PASADENA, CA, 91109-7068, US

(21) Appl. No.: 12/116,549

(22) Filed: May 7, 2008

(30) Foreign Application Priority Data
Nov. 26, 2007 (KR) 10-2007-0120987

(51) Int. Cl. H01J 17/49

(52) U.S. Cl. 313/586

(57) ABSTRACT

A plasma display panel (PDP) for preventing (or reducing) a chemical reaction of Na₂O of a sodalime glass substrate and a metal of an electrode. The PDP includes first and second substrates, a barrier rib, a phosphor layer, an address electrode, and a display electrode. The first and second substrates are provided to face each other, the barrier rib is provided between the first and second substrates to partition discharge cells, and the phosphor layer is formed in each discharge cell. The address electrode is between the first and second substrate and extending in a first direction. The display electrode is between the first and second substrates and extending in a second direction crossing the first direction. Here, the first substrate and/or the second substrate is a sodalime glass substrate including Na₂O, and a frit is between the sodalime glass substrate and the address electrode and/or the display electrode.

### CROSS-REFERENCE TO RELATED APPLICATION

This application claims priority to and the benefit of Korean Patent Application No. 10-2007-0120987, filed in the Korean Intellectual Property Office on Nov. 26, 2007, the entire contents of which are incorporated herein by reference.

### BACKGROUND OF THE INVENTION

1. Field of the Invention

The present invention relates to a plasma display panel (PDP). More particularly, the present invention relates to a PDP for blocking (or reducing) a chemical reaction between a sodalime glass substrate and an electrode.

2. Description of the Related Art

A plasma display panel (PDP) is a display device for realizing an image by gas discharge. That is, the gas discharge generates plasma, the plasma radiates vacuum ultraviolet (VUV) rays, the VUV rays excite phosphors, and the excited phosphors are stabilized to generate red (R), green (G), and blue (B) visible light.

For example, in an alternating current (AC) PDP, address electrodes are formed on a rear substrate, and a dielectric layer is formed on the rear substrate while covering the address electrodes. Barrier ribs are formed in a stripe pattern on the dielectric layer between the respective address electrodes. Red (R), green (G), and blue (B) phosphor layers are formed on inner surfaces of the barrier ribs and on a surface of the dielectric layer.

Display electrodes (e.g., a sustain electrode and a scan electrode formed in pairs) are formed on a front substrate extending in a direction crossing the address electrodes. A dielectric layer and a MgO protective layer are accumulated on an inner surface of the front substrate (or on a surface of the front substrate facing the rear substrate) to cover the display electrodes.

Discharge cells are partitioned by the barrier ribs, and are formed at crossing regions of the address electrodes and the display electrodes. Accordingly, millions (or more) of the discharge cells can be arranged in a matrix format in the PDP.

To reduce the manufacturing cost of the PDP, the front substrate and the rear substrate may be formed of a sodalime glass including a Na₂O component. In addition, to improve electrical conductivity, the address electrode and the display electrode may include metal components (e.g., silver (Ag)).

When the sodalime glass is used as a rear substrate, a migration problem may occur that is caused by a chemical reaction between the Na₂O of the sodalime glass and the silver component of the address electrodes. Therefore, the address electrodes are short circuited, and a vertical line error may be generated.

When the sodalime glass is used as a front substrate, a migration problem may be caused by a chemical reaction between the Na₂O of the sodalime glass and the silver component of a bus electrode of the display electrodes. Therefore, the color of the front substrate is changed, and the color temperature is deteriorated (e.g., resulting in yellowing of the front substrate).

To prevent (or protect from) the above problems, a thin film of SiO₂ is provided to the rear substrate and the front substrate, and the address electrodes and the bus electrodes are formed on the SiO₂ thin film. As such, an additional process for forming the SiO₂ thin film is performed, additional manufacturing units are required, and thereby increasing the manufacturing cost. Therefore, there is a need to provide a method for solving the above problems without an additional manufacturing unit and with a low cost.

The above information disclosed in this Background section is only for enhancement of understanding of the background of the invention and therefore it may contain information that does not form the prior art that is already known in this country to a person skilled in the art.

### SUMMARY OF THE INVENTION

An aspect of an embodiment of the present invention is directed toward a plasma display panel (PDP) for preventing (or reducing) a chemical reaction of Na₂O of a sodalime glass substrate and a metal component of an electrode.

In addition, aspects of embodiments of the present invention are directed toward a plasma display panel (PDP) for preventing (or reducing) a chemical reaction of Na₂O of a rear substrate including a sodalime glass and a silver (Ag) component of an address electrode, and/or for preventing (or reducing) a vertical line error caused by a short-circuit of the address electrode.

Further, aspects of embodiments of the present invention are directed toward a plasma display panel (PDP) for preventing (or reducing) a chemical reaction of Na₂O of a front substrate including a sodalime glass and a silver (Ag) component of a bus electrode, and/or for preventing (or reducing) a color temperature deterioration and a yellowing problem caused by color change of the front substrate.

According to an exemplary embodiment of the present invention, the PDP includes a first substrate; a second substrate facing the first substrate; a barrier rib between the first and second substrates to partition a plurality of discharge cells; a phosphor layer in each of the discharge cells; an address electrode between the first and second substrate and extending in a first direction; and a display electrode between the first and second substrates and extending in a second direction crossing the first direction. Here, at least one of the first substrate or the second substrate is a sodalime glass substrate including Na₂O, and a frit is on the sodalime glass substrate to protect at least one of the address electrode or the display electrode from the sodalime glass substrate.

In one embodiment, the frit layer includes a white filler. The white filler may include TiO₂.

In one embodiment, the first substrate is the sodalime glass substrate, the address electrode includes silver (Ag), and the frit layer is between the address electrode and the first substrate.

In one embodiment, the second substrate is the sodalime glass substrate, the display electrode includes a transparent electrode and a bus electrode, the bus electrode includes silver (Ag), and the frit layer is between the bus electrode and the second substrate.

In one embodiment, the frit layer includes a first frit layer and a second frit layer, the first frit layer is between the address electrode and the first substrate, and the second frit layer is between the display electrode and the second substrate.

In one embodiment, the at least one of the address electrode or the display electrode is isolated from the sodalime glass substrate by the frit.

According to another exemplary embodiment of the present invention, the PDP includes a first substrate being a sodalime glass substrate and including Na₂O; a frit layer on the first substrate; an address electrode on the frit layer, extending in a first direction and being covered by a dielectric layer; a barrier rib for partitioning a plurality of discharge cells on the dielectric layer; a phosphor layer in each of the discharge cells; a second substrate on the barrier rib and having a surface facing the first substrate; and a display electrode extending on the surface of the second substrate in a second direction crossing the first direction.

In one embodiment, the frit layer is on an entire display area of the first substrate.

In one embodiment, the frit layer includes a white filler. The white filler may include TiO₂.

In one embodiment, the address electrode includes silver (Ag).

In one embodiment, the second substrate is a sodalime glass substrate.

In one embodiment, another frit layer is between the display electrode and the surface of the second substrate.

In one embodiment, the display electrode includes a transparent electrode and a bus electrode, the bus electrode includes silver (Ag), and the another frit layer is between the bus electrode and the second substrate.

In one embodiment, the second substrate includes Na₂O.

According to another exemplary embodiment of the present invention, the PDP includes a first substrate; an address electrode extending on the first substrate in a first direction and being covered by a first dielectric layer; a second substrate being a sodalime glass substrate, including Na₂O, and facing the first substrate; a frit layer on a surface of the second substrate facing the first substrate; a display electrode extending on the frit layer in a second direction crossing the first direction and being covered by a second dielectric layer; a barrier rib for partitioning a plurality of discharge cells between the first dielectric layer and the second dielectric layer; and a phosphor layer formed in the each of the discharge cells.

In one embodiment, the frit layer is formed on an entire display area of the second substrate.

In one embodiment, the display electrode includes a transparent electrode and a bus electrode, the bus electrode includes silver (Ag), the transparent electrode is disposed on a corresponding one of the discharge cells, and the bus electrode is on the transparent electrode and the frit layer.

As described, according to the exemplary embodiments of the present invention, since the PDP includes the frit layer on a sodalime glass substrate including Na₂O and an electrode formed on the frit layer, a migration problem caused by a chemical reaction of Na₂O and metal components may be prevented (or reduced).

In addition, when the sodalime glass is applied to the rear substrate, the frit layer is formed on the rear substrate, and the address electrode is formed on the frit layer in the PDP, the migration problem caused by chemical reaction of Na₂O and a silver (Ag) component of the address electrode may be prevented. Therefore, a vertical line error caused by a short-circuit of the address electrode may be prevented.

Further, when the sodalime glass is applied to the front substrate, the frit layer is formed on the front substrate, and the bus electrode is formed on the frit layer in the PDP, the migration problem caused by chemical reaction of Na₂O and the silver (Ag) component of the bus electrode may be prevented. Therefore, color temperature deterioration and a yellowing problem caused by color change of the front substrate may be prevented.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective schematic view of a plasma display panel (PDP) according to an exemplary embodiment of the present invention.

FIG. 2 is a cross-sectional schematic view of the plasma display panel along a line II-II shown in FIG. 1.

FIG. 3 is a top plan schematic view representing a relationship between electrodes and discharge cells.

FIG. 4 is a cross-sectional schematic view of the plasma display panel along a line IV-IV shown in FIG. 1.

Description of Reference Numerals Indicating Primary
Elements in the Drawings

| | |
|---|---|
| 10: First substrate (rear substrate) | 20: Second substrate |
| | (front substrate) |
| 30: Display electrode | 11: Address electrode |
| 13, 21: First and second dielectric layers | 16: Barrier rib |
| 16a, 16b: First and second barrier rib members | 17: Discharge cell |
| 19: Phosphor layer | 23: Protective layer |
| 31: First electrode (sustain electrode) | 32: Second electrode |
| | (scan electrode) |
| 31a, 32a: Transparent electrodes | 31b, 32b: Bus electrodes |
| 41: First frit layer | 42: Second frit layer |

### DETAILED DESCRIPTION OF THE EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween. Like reference numerals designate like elements throughout the specification.

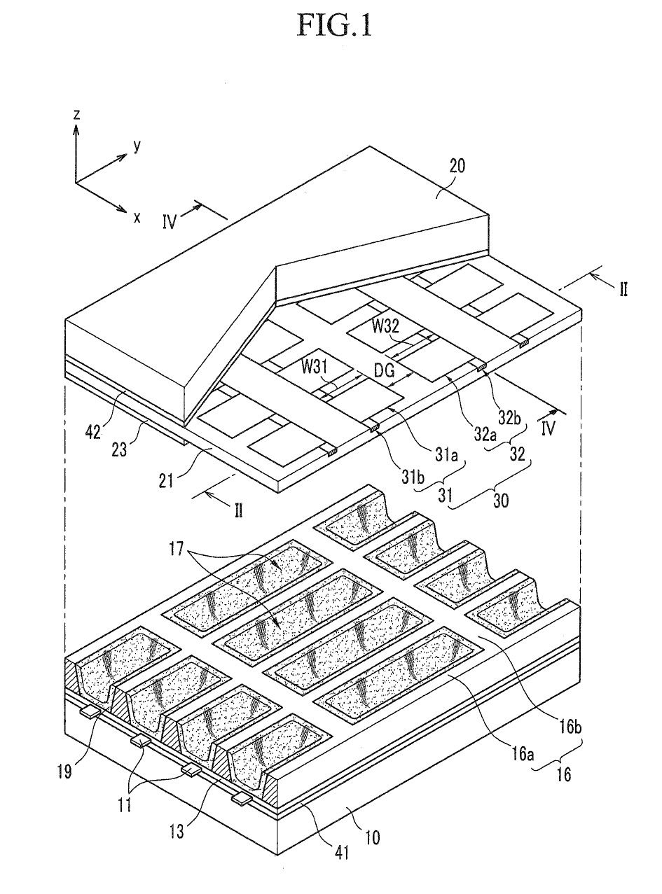

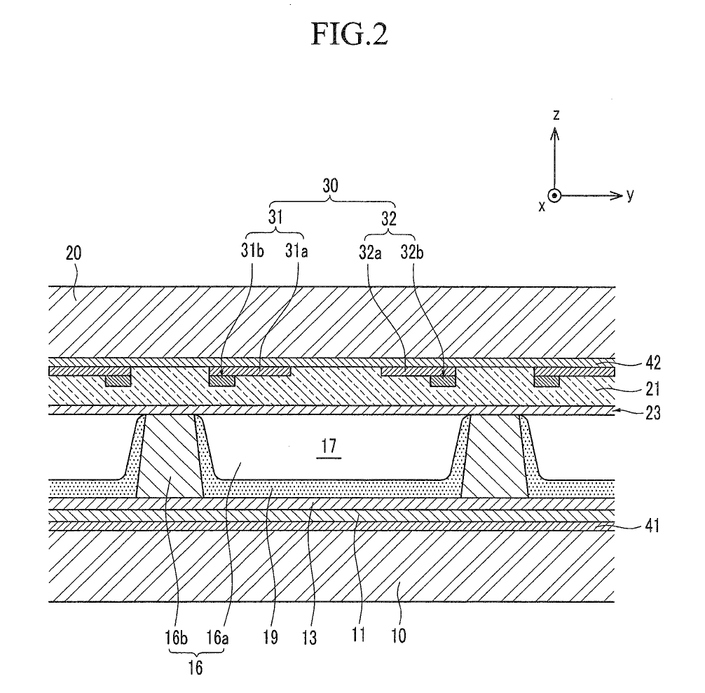

FIG. 1 is an exploded perspective schematic view of a plasma display panel (PDP) according to an exemplary embodiment of the present invention, and FIG. 2 is a cross-sectional schematic view of the plasma display panel along a line II-II shown in FIG. 1.

Referring to FIG. 1 and FIG. 2, the PDP according to the exemplary embodiment of the present invention includes a first substrate 10 (hereinafter also referred to as a “rear substrate”) and a second substrate 20 (hereinafter also referred to as a “front substrate”). Here, the rear and front substrates 10 and 20 face each other and are sealed together. Barrier ribs 16 are formed between the rear and front substrates 10 and 20.

The barrier ribs 16 divide (or partition or define) a plurality of discharge cells 17 between the rear and front substrates 10 and 20. A discharge gas (for example, a mixed gas including neon (Ne) and xenon (Xe)) fills the discharge cells 17 to generate vacuum ultraviolet (VUV) rays when gas discharge is generated. A phosphor layer 19 is formed inside the discharge cells 17, absorbs the VUV rays, and emits visible light.

To realize an image by the gas discharge, the PDP further includes address electrodes 11 and display electrodes 30 that are disposed to correspond to the discharge cell 17 formed between the rear and front substrates 10 and 20.

For example, the display electrode 30 includes a pair of first and second electrodes 31 and 32 (hereinafter also referred to as “sustain and scan electrodes”).

In addition, the rear substrate 10 and the front substrate 20 are formed as glass substrates including an alkali component. That is, the rear substrate 10 and the front substrate 20 are formed of sodalime glass including SiO₂—CaO—Na₂O.

In the PDP, one or both of the rear substrate 10 and the front substrate 20 may be formed of the sodalime glass. When low-cost sodalime glass is used, the manufacturing cost of the PDP may be reduced. In the exemplary embodiment of the present invention, it is illustrated that the both of the rear substrate 10 and the front substrate 20 are formed of the sodalime glass. However, the present invention is not thereby limited.

A frit layer is formed on an inner surface of the substrate formed of the sodalime glass, and the frit layer may not be formed on an inner surface of the substrate that is not formed of the sodalime glass.

Referring to FIG. 1, a first frit layer 41 is formed on an inner surface of the rear substrate 10 (or on a surface of the rear substrate 10 facing the front substrate 20), and a second frit layer 42 is formed on an inner surface of the front substrate 20 (or on a surface of the front substrate 20 facing the rear substrate 10).

The rear substrate 10 is formed of the sodalime glass, and the first frit layer 41 is formed on the inner surface of the rear substrate 10. When the rear substrate is not formed of the sodalime glass, the first frit layer may not be formed on the inner surface of the rear substrate.

The front substrate 20 is formed of the sodalime glass, and the second frit layer 42 is formed on the inner surface of the front substrate 20. When the front substrate is not formed of the sodalime glass, the second frit layer may not be formed on the inner surface of the front substrate.

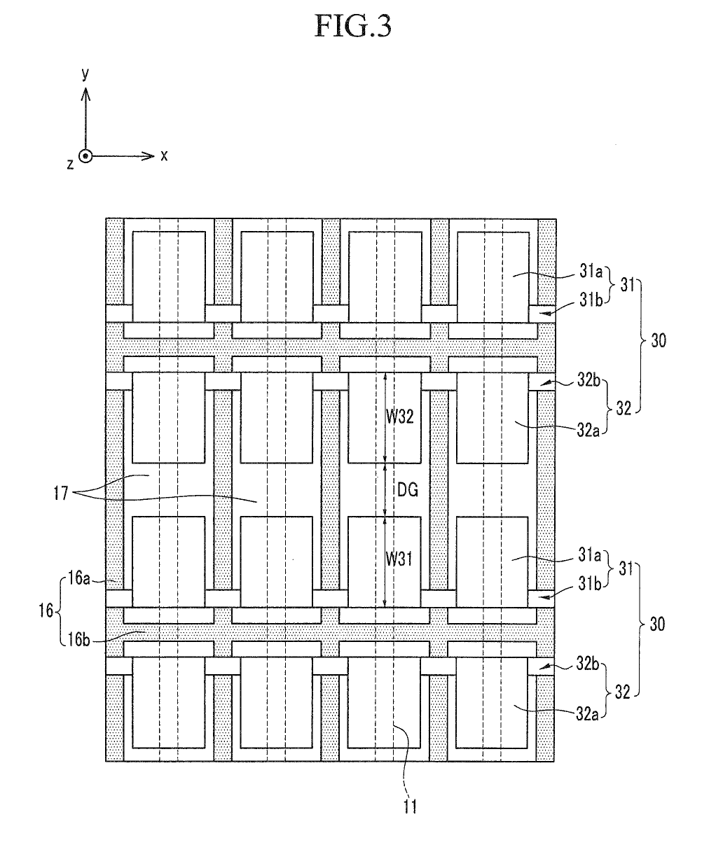

FIG. 3 is a top plan view representing a relationship between electrodes and discharge cells.

Referring to FIG. 3, one address electrode 11 extends in a first direction (i.e., a y axis direction) on the rear substrate 10, and corresponds to a line of discharge cells neighboring each other in the y-axis direction. In addition, the plurality of address electrodes 11 are disposed in parallel along a second direction (i.e., an x axis direction) crossing the y-axis direction.

When the rear substrate 10 is formed of the sodalime glass, the first frit layer 41 is formed on the rear substrate 10, and the address electrode 11 is formed on the first frit layer 41.

A first dielectric layer 13 covers inner surfaces of the address electrodes 11 and the first frit layer 41. The PDP includes a display area for realizing an image and a non-display area formed outside the display area.

The first frit layer 41 is formed on the entire display area of the rear substrate 10, and is formed on a part corresponding to an address electrode terminal connected to the address electrode 11.

The first dielectric layer 13 prevents (or blocks) positive ions or electrons from directly colliding against the address electrodes when a discharge is generated to reduce a deterioration of the address electrodes 11. In addition, the first dielectric layer 13 provides a space for forming and accumulating wall charges.

The address electrode 11 may be formed as an opaque electrode since the address electrode 11 is disposed on the rear substrate 10 because visible light is not prevented from being transmitted to the front. That is, the address electrode 11 may be formed as a metal electrode having high electrical conductivity (e.g., silver (Ag)).

The first frit layer 41 formed between the rear substrate 10 and the address electrode 11 interrupts (or blocks or suppresses) a chemical reaction between Na₂O of the rear substrate 10 and the silver (Ag) component of the address electrode 11.

That is, since the silver (Ag) component of the address electrode 11 and the address electrode terminal are maintained to be separated from the Na₂O of the sodalime glass, the chemical reaction between the silver (Ag) and the Na₂O may be suppressed.

As such, a migration problem caused by the chemical reaction in the rear substrate 10 may be prevented (or reduced), a short-circuit of the address electrode 11 may be prevented (or reduced), and a vertical line error caused by the short-circuit may be prevented (or reduced).

In addition, the first frit layer 41 may further include a white filler or pigment (e.g., TiO₂). The white filler may reflect visible light from the rear substrate 10 toward the front substrate 20 to increase luminance of the PDP.

Compared to a conventional SiO₂ thin film, in the first frit layer 41, an additional manufacturing unit is not required and cost may be reduced.

Barrier ribs 16 are provided on the first dielectric layer 13 to partition the discharge cells 17. The barrier ribs 16 include first barrier rib members 16a extending in the first (or y-axis) direction and second barrier rib members 16b extending between the first barrier rib members 16a in the second (or x-axis) direction such that the discharge cells 17 are formed in a matrix format.

In addition, the barrier ribs 16 may be formed of the first barrier rib members extending in the first (or y-axis) direction without the second barrier rib members so that the discharge cells may be formed in a stripe pattern. That is, the discharge cells may be open along the y-axis direction.

In the exemplary embodiment of the present invention, the barrier ribs 16 forming the discharge cells 17 in a matrix format are illustrated. In the case when the second barrier rib members 16b are eliminated, the discharge cells are formed in a stripe pattern by the first barrier rib members 16a. Illustration of the discharge cells in the stripe pattern is omitted.

In the respective discharge cells 17, a phosphor paste is coated, dried, and baked on a surface of a first dielectric layer 13 positioned between the barrier ribs 16 and a side surface of the barrier ribs 16 to form phosphor layers 19.

The phosphor layers 19 have the same color phosphor in the discharge cells 17 formed along the y-axis direction. In addition, red R, green G, and blue B phosphors are sequentially formed in the phosphor layers 19 in the discharge cells 17 sequentially disposed along the x-axis direction.

The display electrode 30 (i.e., the sustain electrode 31 and the scan electrode 32) is formed on the front substrate 20 to correspond to the respective discharge cells 17 such that a surface discharge can occur. Referring to FIG. 3, the sustain electrode 31 and the scan electrode 32 are formed to extend in an x-axis direction crossing the address electrode 11.

When the front substrate 20 is formed of the sodalime glass, the second frit layer 42 is formed on the front substrate 20, and the sustain electrode 31 and the scan electrode 32 are formed on the second frit layer 42.

The sustain electrode 31 and the scan electrode 32 respectively include transparent electrodes 31a and 32a for generating discharges and bus electrodes 31b and 32b for applying voltage signals to the transparent electrodes 31a and 32a.

The transparent electrodes 31a and 32a generate surface discharges in the discharge cell 17, and are formed of transparent materials (e.g., indium tin oxide (ITO)) to obtain an aperture ratio of the discharge cell 17.

The bus electrodes 31b and 32b are formed of metal materials having high electrical conductivity to compensate for the high electrical resistance of the transparent electrodes 31a and 32a.

The transparent electrodes 31a and 32a respectively form the surface discharge configuration while having widths W31 and W32 from a contour portion of the discharge cell 17 to a center portion of the discharge cell 17 along the y-axis direction, and a discharge gap DG is formed at a center part of each discharge cell 17.

The bus electrodes 31b and 32b are respectively disposed on the transparent electrodes 31a and 32a, and extend along the x-axis direction at the contour portion of the discharge cell 17. Accordingly, when the voltage signal is applied to the bus electrodes 31b and 32b, the voltage signal is applied to the transparent electrodes 31a and 32a respectively connected to the bus electrodes 31b and 32b.

In addition, the transparent electrode may be integrally formed along the x-axis direction to generate discharge in the respective discharge cells.

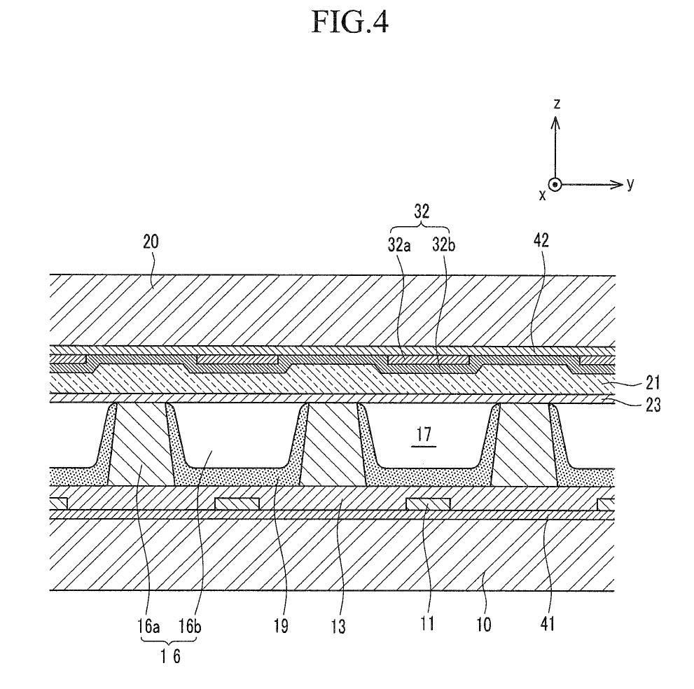

FIG. 4 is a cross-sectional schematic view of the plasma display panel along a line IV-IV shown in FIG. 1.

Referring to FIG. 4, when the transparent electrodes 32a are independently formed on the respective discharge cells 17, the bus electrodes 32b are formed on the transparent electrode 32a and the second frit layer 42.

The bus electrodes 31b and 32b are formed as metal electrodes (e.g., silver) to improve electrical conductivity.

Referring to back to FIG. 3, the sustain electrode 31 and the scan electrode 32 correspond to the discharge cell 17 while crossing the address electrode 11, and they face each other at the discharge cell 17.

A second dielectric layer 21 covers inner surfaces of the sustain electrode 31, the scan electrode 32, and the second frit layer 42. The second frit layer 42 is formed on the entire display area of the front substrate 20, and is formed on the front substrate 20 at a part corresponding to a terminal connected to the sustain electrode 31 and the scan electrode 32.

The second frit layer 42 interrupts (or blocks) the chemical reaction of the Na₂O of the front substrate 20 and the silver component of the bus electrodes 31b and 32b. Accordingly, since the silver component of the bus electrodes 31b and 32b and the terminal is maintained to be separated from the Na₂O of the sodalime glass, the chemical reaction therebetween may be prevented (or reduced). As such, since a color of the front substrate 20 is prevented (or protected) from being changed by the chemical reaction, color temperature deterioration and a yellowing problem may be prevented (or reduced).

In addition, the second frit layer 42 partially absorbs external light on the front substrate 20 so as to improve the contrast ratio. Compared to the conventional SiO₂ thin film, in the second frit layer 42, an additional manufacturing unit is not required and cost may be reduced.

The second dielectric layer 21 protects the sustain electrode 31 and the scan electrode 32 from the gas discharge and provides a space for forming and accumulating wall charges when a discharge is generated.

A protective layer 23 is formed on the second dielectric layer 21 to cover the second dielectric layer 21. For example, the protective layer 23, formed of MgO, protects the second dielectric layer 21, and emits secondary electrons when a discharge is generated.

When the PDP is driven, a reset discharge is generated by a reset pulse applied to the scan electrode 31 during a reset period. During a scan period (or address period) that is subsequent to the reset period, an address discharge is generated by a scan pulse applied to the scan electrode 32 and an address pulse applied to the address electrode 11. Subsequently, during a sustain period, a sustain discharge is generated by a sustain pulse applied to the sustain electrode 31 and the scan electrode 32.

The sustain electrode 31 and the scan electrode 32 apply the sustain pulse for the sustain discharge. The scan electrode 32 applies the reset pulse and the scan pulse. The address electrode 11 applies the address pulse.

Since functions of the sustain electrode 31, the scan electrode 32, and the address electrode 11 may vary according to applied voltage waveforms, they are not limited to the above functions.

In addition, the PDP selectively turns on/off discharge cells 17 by the address discharge caused by the address electrode 11 and the scan electrode 32, and realizes an image by the sustain discharge caused by the sustain electrode 31 and the scan electrode 32 in the selected discharge cells 17.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel comprising:
a first substrate;
a second substrate facing the first substrate;
a barrier rib between the first and second substrates to partition a plurality of discharge cells;
a phosphor layer in each of the discharge cells;
an address electrode between the first and second substrate and extending in a first direction; and
a display electrode between the first and second substrates and extending in a second direction crossing the first direction,
wherein at least one of the first substrate or the second substrate is a sodalime glass substrate comprising Na₂O, and wherein a frit is on the sodalime glass substrate to protect at least one of the address electrode or the display electrode from the sodalime glass substrate.

2. The plasma display panel of claim 1, wherein the frit layer comprises a white filler.

3. The plasma display panel of claim 2, wherein the white filler comprises TiO₂.

4. The plasma display panel of claim 1, wherein the first substrate is the sodalime glass substrate, wherein the address electrode comprises silver (Ag), and wherein the frit layer is between the address electrode and the first substrate.

5. The plasma display panel of claim 1, wherein the second substrate is the sodalime glass substrate, wherein the display electrode comprises a transparent electrode and a bus electrode, wherein the bus electrode comprises silver (Ag), and wherein the frit layer is between the bus electrode and the second substrate.

6. The plasma display panel of claim 1, wherein the frit layer comprises a first frit layer and a second frit layer, wherein the first frit layer is between the address electrode and the first substrate, and wherein the second frit layer is between the display electrode and the second substrate.

7. The plasma display panel of claim 1, wherein the at least one of the address electrode or the display electrode is isolated from the sodalime glass substrate by the frit.

8. A plasma display panel comprising:
a first substrate being a sodalime glass substrate and comprising Na₂O;
a frit layer on the first substrate;
an address electrode on the frit layer, extending in a first direction and being covered by a dielectric layer;
a barrier rib for partitioning a plurality of discharge cells on the dielectric layer;
a phosphor layer in each of the discharge cells;
a second substrate on the barrier rib and having a surface facing the first substrate; and
a display electrode extending on the surface of the second substrate in a second direction crossing the first direction.

9. The plasma display panel of claim 8, wherein the frit layer is on an entire display area of the first substrate.

10. The plasma display panel of claim 8, wherein the frit layer comprises a white filler.

11. The plasma display panel of claim 10, wherein the white filler comprises TiO₂.

12. The plasma display panel of claim 8, wherein the address electrode comprises silver (Ag).

13. The plasma display panel of claim 8, wherein the second substrate is a sodalime glass substrate.

14. The plasma display panel of claim 13, further comprising another frit layer between the display electrode and the surface of the second substrate.

15. The plasma display panel of claim 14, wherein the display electrode comprises a transparent electrode and a bus electrode, wherein the bus electrode comprises silver (Ag), and wherein the another frit layer is between the bus electrode and the second substrate.

16. The plasma display panel of claim 15, wherein the second substrate comprises Na₂O.

17. A plasma display panel comprising:
a first substrate;
an address electrode extending on the first substrate in a first direction and being covered by a first dielectric layer;
a second substrate being a sodalime glass substrate, comprising Na₂O, and facing the first substrate;
a frit layer on a surface of the second substrate facing the first substrate;
a display electrode extending on the frit layer in a second direction crossing the first direction and being covered by a second dielectric layer;
a barrier rib for partitioning a plurality of discharge cells between the first dielectric layer and the second dielectric layer; and
a phosphor layer formed in the each of the discharge cells.

18. The plasma display panel of claim 17, wherein the frit layer is formed on an entire display area of the second substrate.

19. The plasma display panel of claim 17, wherein the display electrode comprises a transparent electrode and a bus electrode, wherein the bus electrode comprises silver (Ag), wherein the transparent electrode is disposed on a corresponding one of the discharge cells, and wherein the bus electrode is on the transparent electrode and the frit layer.
